(19) United States
(12) Patent Application Publication
(10) Pub. No.: US 2014/0103993 A1
(43) Pub. Date: Apr. 17, 2014

(54) CHIP DYNAMIC VOLTAGE REGULATOR CIRCUIT AND TERMINAL DEVICE

(71) Applicant: Huawei Technologies Co., Ltd., Shenzhen (CN)

(72) Inventors: Yuzhu Chen, Shenzhen (CN); Tao Huang, Shenzhen (CN)

(73) Assignee: HUAWEI TECHNOLOGIES CO., LTD., Shenzhen (CN)

(21) Appl. No.: 14/051,524

(22) Filed: Oct. 11, 2013

(30) Foreign Application Priority Data
Oct. 12, 2012 (CN) 201210387131.0

(51) Int. Cl. G05F 1/46

(52) U.S. Cl. CPC G05F 1/46
USPC 327/540

(57) ABSTRACT

The present invention provides a chip dynamic voltage regulator circuit and a terminal device. The voltage regulator circuit includes: a parameter detecting module, configured to detect an attribute parameter of a chip; a Pulse Width Modulation (PWM) signal generating module, configured to generate a corresponding PWM digital signal according to the detected attribute parameter, and convert the PWM digital signal into an analog signal having a direct-current voltage; and a power supply module, including a DC-DC converter or a low-dropout regulator, which is configured to regulate an output voltage according to the analog signal that is fed back and a feedback signal of the voltage output end of the voltage regulator circuit. The present invention is capable of accurately regulating an output voltage according to an analog signal converted from a PWM digital signal, thereby implementing dynamic voltage regulation for a chip at a low cost and avoiding power waste.

### CROSS-REFERENCE TO RELATED APPLICATIONS

This application claims priority to Chinese Patent Application No. 201210387131.0, filed on Oct. 12, 2012, which is hereby incorporated by reference in its entirety.

### TECHNICAL FIELD

Embodiments of the present invention relate to electrical technologies, and in particular, to a chip dynamic voltage regulator circuit and a terminal device.

### BACKGROUND

As the integration and speed of a System on Chip (SoC) keep increasing, a supply current of a chip core becomes greater and greater, and power consumption of the chip occupies a large proportion of power consumption of the overall system where the chip is located. Therefore, if the power consumption of the chip core can be reduced, the power consumption of the overall system may be reduced.

One of the ways to reduce power consumption of a chip core is to provide a matching supply voltage to the chip, thereby avoiding power consumption caused by an excessive voltage. At present, process deviation of a chip may result in different requirements on a voltage of a chip core. For example, according to a difference in growth speeds of semiconductor materials in chips, chips are classified into types of SS, TT, and FF, etc. Chips of different process types require different core voltages. In order to reduce the loss of chip yields as much as possible, a manufacturer normally publishes a higher voltage for a chip core, to satisfy working conditions of a lowest voltage for a chip core. For example, a core voltage satisfying working conditions of an SS chip needs to be higher. This voltage exceeds the requirements of TT and FF chips, resulting in increased power consumption thereof. Therefore, there is certain power waste in a product that uses a fixed chip core voltage.

In order to reduce power consumption of a chip core, the prior art proposes a technology of dynamically regulating a supply voltage for a chip. The prior art uses a Power Management Unit (PMU) to supply power to a SoC chip, where an I2C bus or an SPI bus between the PMU and the SoC chip may be used, and a digital control signal is generated by a CPU in the SoC chip and is fed back to a digital control interface of the PMU, to regulate an output voltage of the PMU to implement dynamic voltage regulation. However, this solution has a high cost. Because a logic circuit for processing a digital signal needs to be added in the PMU, a cost of the PMU having the function of dynamic voltage regulation is typically at least 30% higher than a cost of a DC-DC converter of the same specification.

### SUMMARY

Embodiments of the present invention provide a chip dynamic voltage regulator circuit and a terminal device, to reduce power consumption of a chip core and reducing a cost of a product by implementing dynamic regulation for a supply voltage of a chip.

An embodiment of the present invention provides a chip dynamic voltage regulator circuit, including:

a parameter detecting module, configured to detect an attribute parameter of a chip;

a PWM signal generating module, configured to generate a corresponding PWM digital signal according to the detected attribute parameter, and convert the PWM digital signal into an analog signal having a direct-current voltage by using a low-pass filter; and

a power supply module, including a DC-DC converter or a low-dropout regulator, where the DC-DC converter or the low-dropout regulator includes an error amplifier, and a feedback input end of the error amplifier is connected to a signal output end of the PWM signal generating module and a voltage output end of the chip dynamic voltage regulator circuit, and is configured to regulate an output voltage according to the analog signal that is converted from the PWM digital signal and is fed back and a feedback signal of the voltage output end of the chip dynamic voltage regulator circuit.

An embodiment of the present invention further provides a terminal device including a chip, and further including a chip dynamic voltage regulator circuit according to any embodiment of the present invention.

The chip dynamic voltage regulator circuit according to the embodiment of the present invention is capable of accurately regulating an output voltage according to an analog signal corresponding to a PWM digital signal by using an existing power supply circuit structure including an error amplifier and based on the change of an attribute parameter of a chip, thereby implementing dynamic voltage regulation for a chip at a low cost and avoiding power waste.

### BRIEF DESCRIPTION OF DRAWINGS

FIG. 1 is a schematic structural diagram of a chip dynamic voltage regulator circuit according to a first embodiment of the present invention;

FIG. 2 is a schematic diagram of correspondence between analog signal levels and PWM digital signals;

FIG. 3 is a schematic structural diagram of a chip dynamic voltage regulator circuit according to a second embodiment of the present invention;

FIG. 4 is a schematic structural diagram of an example of a chip dynamic voltage regulator circuit according to the present invention; and

FIG. 5 is a schematic structural diagram of another example of a chip dynamic voltage regulator circuit according to the present invention.

### DESCRIPTION OF EMBODIMENTS

### Embodiment 1

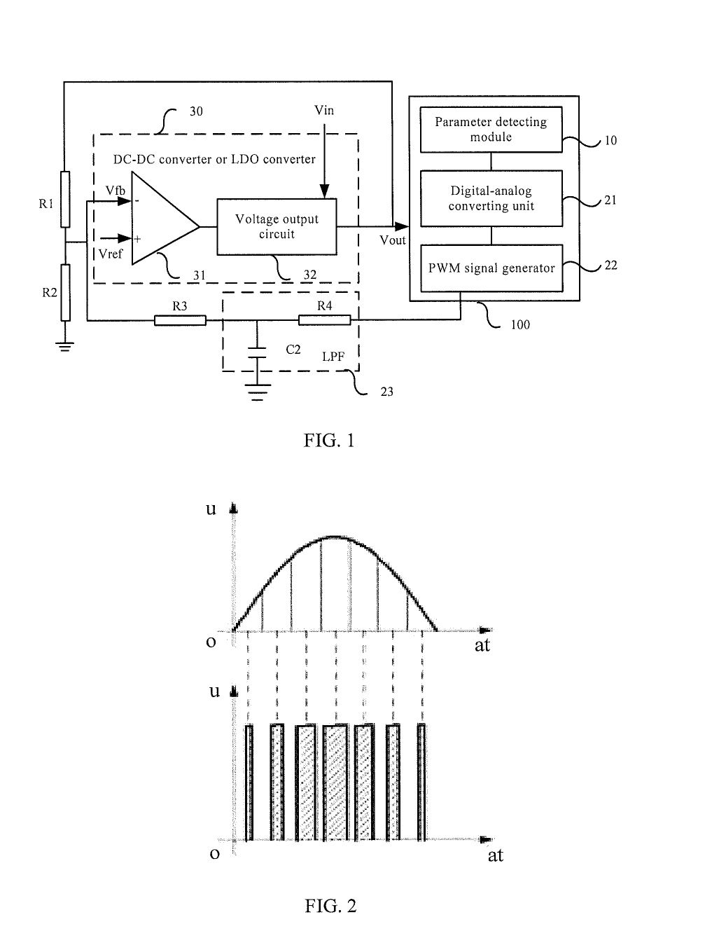

FIG. 1 is a schematic structural diagram of a chip dynamic voltage regulator circuit according to the first embodiment of the present invention. The circuit is suitable for supplying power to a system having a SoC chip, and is capable of dynamically regulating a voltage. The circuit specifically includes a parameter detecting module 10, a Pulse Width Modulation (PWM) signal generating module, and a power supply module 30. The parameter detecting module 10 is configured to detect an attribute parameter of a chip 100, and may be configured in the chip 100 or be configured separately from the chip 100 as long as a parameter detecting function may be completed. The PWM signal generating module is configured to generate a corresponding PWM digital signal according to the detected attribute parameter, and convert, by using a low-pass filter, the PWM digital signal into an analog signal having a direct-current voltage. The power supply module 30 includes a DC-DC converter or a Low-DropOut regulator (LDO), where the DC-DC converter or the LDO includes an error amplifier 31, and a feedback input end of the error amplifier 31 is connected to a signal output end of the PWM signal generating module and a voltage output end of the chip dynamic voltage regulator circuit, and is configured to regulate an output voltage Vout according to the analog signal that is converted from the PWM digital signal and is fed back and a feedback signal of the voltage output end of the chip dynamic voltage regulator circuit.

In the embodiment, a power supply circuit may directly use a DC-DC converter or an LDO converter, where a main structure of this type of power supply circuit includes the error amplifier 31 and a voltage output circuit 32.

A non-inverting input end of the error amplifier 31 is connected to a reference voltage source Vref. An inverting input end of the error amplifier 31 is connected as a feedback input end to the PWM signal generating module to receive the analog signal converted from the PWM digital signal. The error amplifier 31 is configured to output a voltage difference between a voltage input by the feedback input end and the reference voltage source, that is, a voltage difference between the analog signal as well as an output voltage and the reference voltage source. An input end of the voltage output circuit 32 is connected to an output end of the error amplifier 31 to obtain the voltage difference, and after the input voltage Vin is regulated according to the voltage difference, the regulated input voltage is supplied to the chip 100 as an output voltage, where the output voltage is fed back to the inverting input end of the error amplifier 31 as a feedback voltage Vfb.

In the embodiment of the present invention, the detected attribute parameter of the chip is a parameter that may affect a voltage requirement of a chip core, such as a process parameter of the chip, and a scene where the chip is running. The corresponding output voltage may be obtained according to the attribute parameter of the chip. Correspondence between the attribute parameter and the output voltage may be a set mapping relationship. A supply voltage required by a system corresponding to different attribute parameters of chips may be tested and determined in advance by a designer by experience and experiments. Then, a determined voltage value may be identified in the form of a PWM digital signal having a set duty ratio, and then the PWM digital signal is converted into an analog signal having a direct-current voltage.

That is, the PWM signal generating module preferably includes a digital-analog converting unit 21, a PWM signal generator 22, and a Low-Pass Filter (LPF) 23, and as shown in FIG. 1, may further include a voltage divider resistor R3 according to a requirement. The digital-analog converting unit 21 is configured to convert, based on the set mapping relationship, the detected attribute parameter into a corresponding voltage. The PWM signal generator 22 is configured to generate, according to the voltage, a PWM digital signal having a corresponding duty ratio. The LPF 23 is configured to convert the PWM digital signal into an analog signal having a direct-current voltage. The LPF 23 is available in multiple forms. Typically an RC is used to make a low-pass filter, as shown in FIG. 1.

It is well known that PWM is a method for digitally encoding an analog signal level. By using a high resolution counter, the duty ratio of a square wave is modulated to encode a specific analog signal level. A PWM signal is still digital because a direct-current power supply of full amplitude is either completely on or completely off at any given moment. A voltage or current is applied to an analog load as a repetitive pulse sequence that is either on) or off. When it is on, a direct-current is applied to the load. When it is off, the power supply is stopped. As long as a bandwidth is sufficient, any analog value may be encoded by using PWM, and the duty ratio of a high level of a PWM digital signal is used to correspond to a different analog value. As shown in FIG. 2 FIG. 2 is a schematic diagram of correspondence between analog signal levels and PWM digital signals.

The technical solution of the embodiment is capable of dynamically regulating, by using an error amplifier and an existing chip power supply circuit such as a voltage output circuit and additionally using the analog signal converted from the PWM digital signal as a feedback control signal, a voltage to be supplied to a system where the chip is located, thereby avoiding power waste of an excessive voltage.

In an existing chip power supply circuit, normally a DC-DC converter or an LDO converter is configured to boost or decrease an input voltage according to a requirement, and perform a voltage regulating operation on the input voltage at the same time. A converter of this type include an error amplifier, where a non-inverting input end of the error amplifier is connected to a reference voltage source Vref, and an inverting input end is connected to a feedback voltage Vfb, that is, a voltage fed back from an output voltage. Further the feedback voltage may be obtained through an output voltage sampling circuit, where the output voltage sampling circuit is configured to divide the output voltage and then feed it back to the inverting input end of the error amplifier. As shown in FIG. 1, the output voltage sampling circuit typically includes two voltage dividing resistors R1 and R2. Then, after the converting and voltage regulating processing by the voltage output circuit 32, the output voltage Voutbase may be finely adjusted based on the following equation, and a stable voltage output is obtained:

Voutbase=Vref·(1+R1/R2)

The technical solution according to the embodiment of the present invention uses the circuit structure of the error amplifier and the voltage output circuit, and further configures the PWM signal generating module, where the analog signal Vpwm converted from the PWM digital signal is a direct-current voltage signal that changes according to a specific duty ratio, which is also equivalent to the feedback value of the output voltage. The solution is capable of regulating the output voltage by using the error amplifier and the voltage output circuit. Then, the output voltage Vout according to the embodiment of the present invention is determined according to the following equation:

$$\begin{matrix}Vout = Vref \cdot ( 1 + R 1 / R 2 ) + ( Vref - Vpwm ) ( R 1 / ( R 3 + R 4 ) ) \\ = Voutbase + ( Vref - Vpwm ) ( R 1 / ( R 3 + R 4 ) )\end{matrix}$$

In such a case, it is possible that the output voltage itself may not fluctuate, and the change of the output voltage may be controlled and regulated because of the change of a voltage requirement on a chip core caused by the change of an attribute parameter such as a chip process. As can be seen from the above equation, Vref, R1, R2, R3, and R4 are all constants. Therefore, the output voltage Vout is controlled by the analog signal Vpwm converted from the PWM digital signal.

The technical solution according to the embodiment of the present invention is capable of dynamically regulating a voltage of a chip and has a low cost, that is, a cost of a power supply circuit does not need to be increased. Improvement on a chip side may also be implemented by using software. The PWM signal generator may be provided additionally, or an existing PWM signal generator in a system where the chip is located may be used.

### Embodiment 2

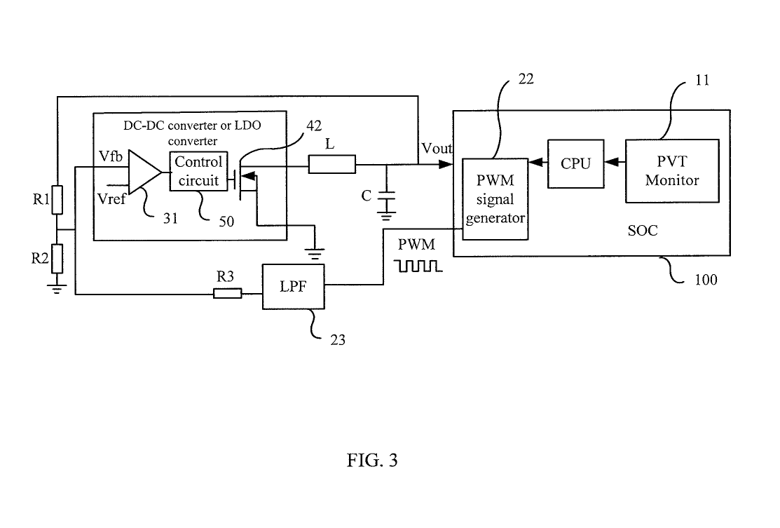

FIG. 3 is a schematic structural diagram of a chip dynamic voltage regulator circuit according to the second embodiment of the present invention. In the embodiment, a parameter detecting module includes a chip process monitor PVT Monitor 11 configured to detect a process attribute parameter of a chip 100. The chip process monitor 11 may detect a chip process by using the prior art, which is mainly detecting process values of the chip 100. For example, a chip of FF, TT, or SS type has a different process value and chips of FF, TT, and SS types are divided according to a specific value range.

In a PWM signal generating module, a digital-analog converting unit is configured to convert, based on a set mapping relationship, the detected attribute parameter into a corresponding voltage. This function may be implemented by using an existing CPU in the chip as software. A structure of a common PWM signal generator is known to those skilled in the art, and details are not described herein.

A DC-DC converter or an LDO converter is specifically used in the embodiment, and a peripheral circuit is used in cooperation to implement an error amplifier 31 and a voltage output circuit. In the converter, another control circuit 50 may be configured according to a requirement to implement other functions, which is not restricted in the embodiment.

In the embodiment, a voltage output circuit preferably includes an LC circuit and a switching transistor 42. A capacitor C of the LC circuit is configured to provide an output voltage to the chip 100. The LC circuit constitutes a common low-pass filter, and can output a voltage with a rather small ripple. A control end of the switching transistor 42 is connected to an output end of the error amplifier 31, to set the LC circuit to be on or off under the control of a voltage difference. As shown in FIG. 3, the LC circuit is controlled by an N-Mental-Oxide-Semiconductor (NMOS) transistor. The duty ratio of the analog signal converted from a PWM digital signal affects the voltage difference output by the error amplifier, and the voltage difference may control the NMOS transistor to be on or off, thereby regulating the output voltage by using the LC circuit. The analog signal converted from the PWM digital signal is used as a feedback signal, which can quickly control the switching transistor to be on or off, so that the dynamic voltage regulation of the output voltage is quicker.

In the embodiment, the operating process of the chip dynamic voltage regulator circuit is as follows:

after a PVT Monitor is powered on and detects a process attribute parameter of a SoC chip, it feeds back a value to a CPU;

the CPU determines a voltage according to the feedback value, and performs digital encoding on the voltage by setting a duty ratio of a PWM digital signal;

the PWM digital signal is generated by the PWM generator and goes through a low-pass filter, to output an analog signal in the form of a direct-current voltage to a feedback pin of a DC-DC converter or an LDO converter, that is, to the inverting input end of the error amplifier; and

an output voltage is determined by using voltage dividing resistors R1 and R2, resistors R3 and R4 connected in an analog signal transmission circuit, a reference voltage source Vref, a parameter of the LPF, and the duty ratio of the analog signal, where R1, R2, R3, R4, Vref, and the parameter of the LPF are constants normally, so the dynamic change of the output voltage is controlled by the duty ratio of the analog signal.

Compared with the prior art, the technical solution according to the embodiment increases no cost or increases only the cost of an RC filter circuit. Therefore, the implementation cost is very low.

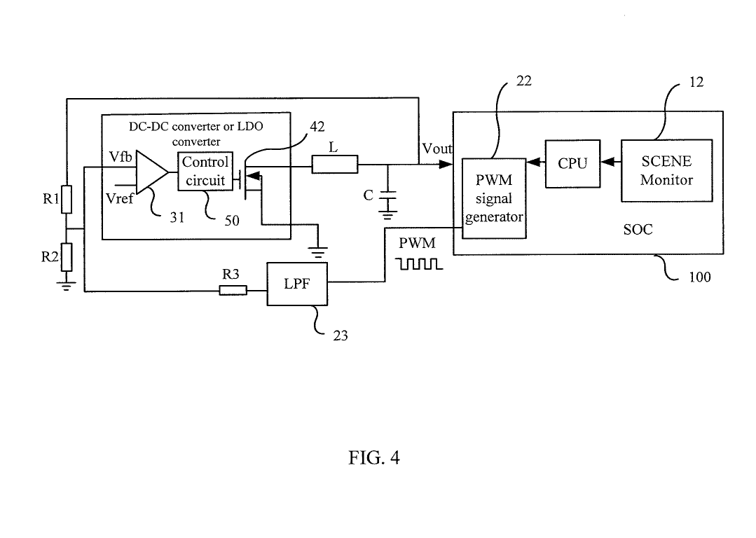

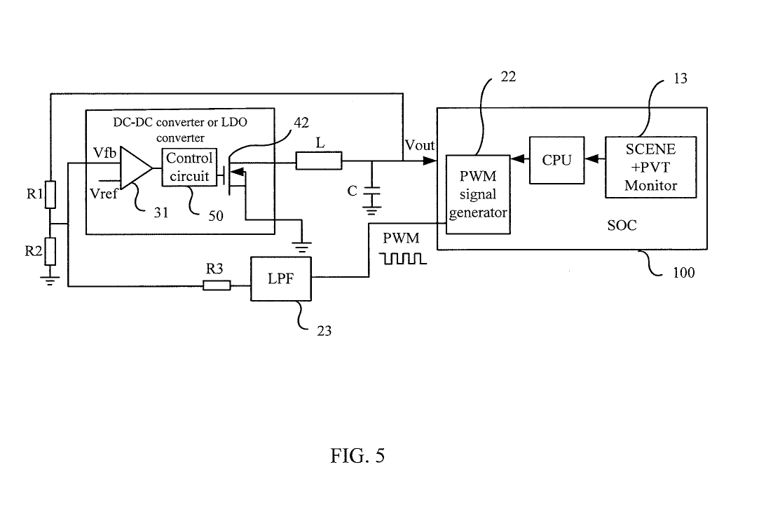

A parameter detecting module in the embodiment of the present invention is not limited to a PVT monitor. The parameter detecting module may also include a SCENE Monitor 12 as shown in FIG. 4, which is configured to detect a scene state attribute parameter of a device where the chip is located. Alternatively, the parameter detecting module may include SCENE+PVT monitor 13 which comprises a chip process monitor and scene monitor, as shown in FIG. 5. The scene state attribute parameter is a state parameter of a system where the chip is located. For example, a mobile phone with a chip may operate in multiple scenes, such as playing a video, playing an audio, being standby, and displaying a document. A difference among service amounts processed by the system within the same period is also a scene state attribute parameter. Voltage requirements of a chip core are different in different scene states, and power supply requirements of the system are different, which may be the basis for controlling the dynamic regulation of the output voltage. Therefore, various state parameters that may affect a voltage of a chip core may be determined as scene state attribute parameters according to actual requirements.

An embodiment of the present invention further provides a terminal device which includes a chip and a chip dynamic voltage regulator circuit according to any embodiment of the present invention. The terminal device is one of specific forms of a system including a chip, such as a mobile phone and a tablet computer; and it is capable of implementing the dynamic change of a voltage of a SoC core under the precondition that a cost almost does not increase, thereby efficiently reducing power consumption of a complete product.

With the development of low power consumption and green concepts, and as consumer electronic products have higher and higher requirements on power consumption, a solution to reduce power consumption at a low cost may be in batch applications in many fields. This technical solution may be applied in any product field where a SoC chip is used, where the SoC chip is integrated with a PVT Monitor, a SCENE monitor, or similar functions and has multiple operating modes, and different operating modes may correspond to different voltages.

Persons of ordinary skill in the art should understand that all or a part of the steps of the method according to the embodiments may be implemented by a program instructing relevant hardware. The program may be stored in a computer readable storage medium. When the program is run, the steps of the method according to the embodiments are performed. The storage medium may be any medium capable of storing program codes, such as a ROM, a RAM, a magnetic disk, or a CD-ROM.

Finally, it should be noted that the above embodiments are merely provided for describing the technical solutions of the present invention, but are not intended to limit the present invention. It should be understood by persons of ordinary skill in the art that although the present invention has been described in detail with reference to the embodiments, modifications may be made to the technical solutions described in the embodiments, or equivalent replacements may be made to some or all technical features in the technical solutions; however, such modifications or replacements do not cause the essence of the corresponding technical solutions to depart from the scope of the technical solutions according to the embodiments of the present invention.

What is claimed is:

1. A chip dynamic voltage regulator circuit, comprising:
a parameter detecting module, configured to detect an attribute parameter of a chip;
a Pulse Width Modulation (PWM) signal generating module, configured to generate a corresponding PWM digital signal according to the detected attribute parameter, and convert the PWM digital signal into an analog signal having a direct-current voltage by using a low-pass filter; and
a power supply module, comprising a DC-DC converter or a low-dropout regulator, wherein the DC-DC converter or the low-dropout regulator comprises an error amplifier, and a feedback input end of the error amplifier is connected to a signal output end of the PWM signal generating module and a voltage output end of the chip dynamic voltage regulator circuit, and the DC-DC converter or the low-dropout regulator is configured to regulate an output voltage according to the analog signal converted from the PWM digital signal and a feedback signal of the voltage output end of the chip dynamic voltage regulator circuit.

2. The chip dynamic voltage regulator circuit according to claim 1, wherein the parameter detecting module comprises:
a chip process monitor, configured to detect a process attribute parameter of the chip; and/or
a scene monitor, configured to detect a scene state attribute parameter of a device where the chip is located.

3. The chip dynamic voltage regulator circuit according to claim 1, wherein the PWM signal generating module comprises:
a digital-analog converting unit, configured to convert, based on a set mapping relationship, the detected attribute parameter into a corresponding voltage;
a PWM signal generator, configured to generate, according to the voltage, the PWM digital signal having a corresponding duty ratio; and
a low-pass filter, configured to convert the PWM digital signal into the analog signal having the direct-current voltage.

4. The chip dynamic voltage regulator circuit according to claim 1, wherein the DC-DC converter or the low-dropout regulator comprises:
the error amplifier, wherein a non-inverting input end of the error amplifier is connected to a reference voltage source, an inverting input end of the error amplifier is used as the feedback input end, and the error amplifier is configured to output a voltage difference, wherein the voltage difference is a voltage difference between a voltage input by the feedback input end and the reference voltage source; and
a voltage output circuit, wherein an input end of the voltage output circuit is connected to an output end of the error amplifier to obtain the voltage difference, and after the input voltage is regulated according to the voltage difference, the regulated input voltage is supplied to the chip as the output voltage.

5. The chip dynamic voltage regulator circuit according to claim 4, further comprising:
an output voltage sampling circuit, configured to divide the output voltage and then feed it back to the inverting input end of the error amplifier.

6. The chip dynamic voltage regulator circuit according to claim 1, wherein the voltage output circuit comprises:
an LC circuit, wherein a capacitor of the LC circuit is configured to provide the output voltage to the chip; and
a switching transistor, wherein a control end of the switching transistor is connected to the output end of the error amplifier, to set the LC circuit to be on or off under the control of the voltage difference.

7. A terminal device, comprising a chip, and further comprising the chip dynamic voltage regulator circuit according to claim 1.
